(19) United States
(12) Patent Application Publication
(10) Pub. No.: US 2026/0270904 A1
(43) Pub. Date: Sep. 10, 2026

(54) TIME SYNCHRONIZATION FOR OFFLINE DEVICES

(71) Applicant: Eaton Intelligent Power Limited, Dublin 4 (IE)

(72) Inventors: Rohit Ramchandra Deshpande, Pune (IN); Sonali Sameer Londhe, Pune (IN); Abhijit Dattatray Gundawar, Pune (IN)

(21) Appl. No.: 19/491,319

(22) PCT Filed: Jun. 4, 2024
(86) PCT No.: PCT/IB2024/055462

§ 371 Date: Dec. 8, 2025

(30) Foreign Application Priority Data
Jun. 8, 2023 (IN) 202311039388

(51) Int. Cl. H04W 56/00; H04W 84/18

(52) U.S. Cl. CPC H04W 56/0015; H04W 84/18

(57) ABSTRACT

A method of time synchronization in an offline environment is provided. The method includes connecting an electronic device in a mesh network of electronic devices so that the mesh network includes the electronic device and other electronic devices, wherein the electronic devices each includes a clock set to a time and comparing, by the electronic device, the time on the clock to a time range to determine that the time is within a time range indicating an invalid time. Responsive to the determination that the time is within the time range indicating an invalid time, communicating, by the electronic device, a time request message to the other electronic devices in the mesh network, receiving, by the electronic device, a valid time from one of the other electronic devices in the mesh network, and synchronizing, by the electronic device, the clock with the valid time.

### BACKGROUND

Electronic devices such as hazardous area light fixtures can be configured as part of a mesh network to enable collective control. In certain industrial applications, cloud/external network connectivity may not be possible or available for these electronic devices, resulting in the devices effectively operating offline. The lack of online access from the devices themselves as well as potentially any mobile device that may be used to provide an over-the-air (OTA) update creates a constraint on the features available to these electronic devices.

The mesh may be programmed to an automatic schedule (e.g., lights at full brightness during the day, but half brightness in the evening) to further promote efficiency and convenience on the premises. However, if the power is lost or an event occurs where a particular device is reset, the time at the particular device will be lost. In some cases, a back-up power is provided for the electronic devices, for example, in the form of a supercapacitor. However, a supercapacitor is costly and may not operate efficiently (or safely) at temperatures that may be found in the hazardous environments where it is possible the electronic devices are operated. It can be possible to provide a correct time using a mobile device; however, it is not possible to synchronize time amongst the devices when the external network is not available.

### BRIEF SUMMARY

Time synchronization for offline devices is provided. Through the described methods, it is possible to create a virtual cloud for synchronizing the time of electronic devices configured in a mesh network in case external connectivity is not available.

A method of time synchronization in an offline environment includes connecting an electronic device in a mesh network of electronic devices so that the mesh network incudes the electronic device and other electronic devices, wherein the electronic devices each includes a clock set to a time and comparing, by the electronic device, the time on the clock to a time range to determine that the time is within a time range indicating an invalid time. Responsive to the determination that the time is within the time range indicating an invalid time, communicating, by the electronic device, a time request message to the other electronic devices in the mesh network, receiving, by the electronic device, a valid time from one of the other electronic devices in the mesh network, and synchronizing, by the electronic device, the clock with the valid time.

A method of creating a virtual cloud network to synchronize a time when a mesh network of electronic devices is offline includes connecting a first electronic device and a second electronic device in a mesh network of electronic devices, receiving, by the first electronic device, a time request message from the second electronic device, and comparing, by the first electronic device, the time on the respective clock of the first electronic device to a first time to determine a valid time. Responsive to determining the time on the respective clock of the first electronic device indicates the valid time, waiting, by the first electronic device, an amount of time based on an electronic device identification number of the first electronic device, and when a first update time message is not received by the first electronic device during the amount of time, communicating, by the first electronic device, the time on the respective clock of the first electronic device in a second update time message to the second electronic device.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

FIG. 1 illustrates an example operating environment of mesh devices.

FIG. 2 illustrates a schematic diagram of an electronic device.

FIG. 3 illustrates a process flow describing a method of time synchronization.

FIG. 4 illustrates a process flow describing a method of creating a virtual cloud network to synchronize a time when a mesh network of electronic devices is offline.

FIG. 5 illustrates an example scenario of time synchronization for offline devices.

### DETAILED DESCRIPTION

Time synchronization for offline devices is provided. Through the described methods, it is possible to create a virtual cloud for synchronizing the time of electronic devices configured in a mesh network in case external connectivity is not available.

A time, for the purposes of the disclosure, includes both a date (e.g., Jan. 1, 2022) along with a time (e.g., 23:00). While a first electronic device, a second electronic device, and a third electronic device have been utilized for illustrative purposes, the number of electronic devices in the mesh network can be any number. For example, there may be 100 electronic devices in the mesh network.

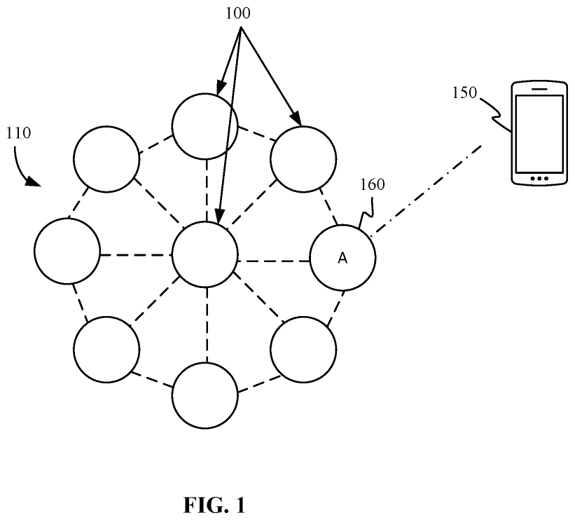

FIG. 1 illustrates an example operating environment of mesh devices. Referring to FIG. 1, a plurality of electronic devices 100 can communicate with each other over a mesh network 110. The mesh network can be a Bluetooth® low energy (BLE) mesh, Zigbee mesh, Wi-Fi mesh, as well as other wireless networks. The devices 100 are represented as nodes in the mesh network 110. The mesh network may be a partially connected mesh network or a fully connected mesh network. Nodes in the network 110 can relay messages by flooding (the message is sent through every outgoing link except the one the message was received from) or routing (the message hops from node to node until it reaches its destination). When communicating by a flooding technique, controlled flooding may be used, for example SNCP (Sequence Number Controlled Flooding) and RPF (reverse path forwarding).

For a device that is not part of the mesh network, such as mobile device 150, communication on the mesh network 110 is conducted via a proxy device 160. The mobile device 150 configures the plurality of electronic remote devices 100 (i.e., provisioning) into the mesh network 110 and controls features on the plurality of electronic remote devices 100 via a mobile application running on the mobile device 150. In order to ensure that this provisioning operation is done securely, the mobile application and the proxy device 160 authenticate one another to make sure that the proxy device 160 is a valid device and that the mobile application is valid to communicate with the mesh network 110. When there is cloud connectivity, the mobile application communicates directly with a cloud network in order to conduct this validation via a cryptographic application in the cloud network. During cloud connectivity, the current local time is read from a cloud server and communicated from the mobile device 150 to each of the plurality of electronic remote devices 100 in the mesh network 110 via the proxy device 160 by a broadcast mechanism. All the nodes in the mesh network 110 are capable of transferring data to a nearby node in the same mesh network using the broadcast mechanism such that all nodes receive the information simultaneously and hence do not send an acknowledgement. Many times, however, the mesh network 110 is located in areas without cloud connectivity and/or access to the mobile device 150.

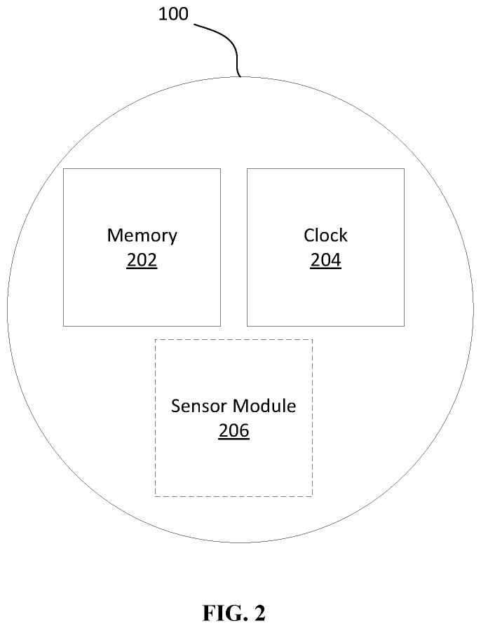

FIG. 2 illustrates a schematic diagram of an electronic device. The electronic device 100 includes a memory 202 and a clock 204. The memory 202 is a non-volatile memory that can include an internal memory and flash memory. The clock 204 on the electronic device 100 (along with the respective clocks on the other electronic devices in the mesh) can be utilized to set a schedule for the mesh network 110. Each electronic device 100 includes a default time hardcoded in the internal memory. In an embodiment, the default time is Jan. 1, 1970. The time from the clock 204 can be stored in flash memory. In some cases, the electronic device 100 includes a sensor module 206 having a supercapacitor. The supercapacitor can provide a battery backup to the electronic device 100 when the electronic device cannot obtain power through other means, such as through an online network. In some cases, the sensor module 206 can be plug and play to enable it to be removable from the electronic device 100 and installed on another electronic device.

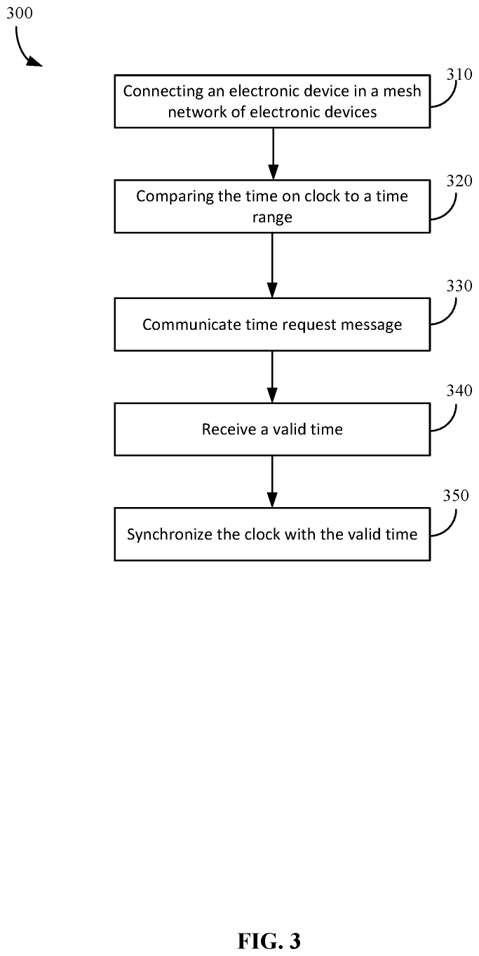

FIG. 3 illustrates a process flow describing a method of time synchronization in an offline environment. In some cases, method 300 begins upon power-up of an electronic device 100. In other cases, the method 300 is performed periodically at a specific time interval. For example, the method 300 can be performed every 24 hours at 2 AM. Referring to FIG. 3, the method 300 includes connecting (310) an electronic device 100 into a mesh network 110 such as that shown in FIG. 1. The mesh network 110 includes the electronic device and other electronic devices 100. Each of the electronic devices 100 within the mesh network 110 includes a clock 204 set to a time. The electronic device 100 compares (320) the time on the clock 204 to a time range to determine that the time is within the time range indicating an invalid time. Responsive to the determination that the time is within the time range indicating the invalid time, communicating, (330) by the electronic device 100, a time request message to the other electronic devices 100 in the mesh network 110, receiving (340) a valid time from one of the other electronic devices 100 in the mesh network 110, and synchronizing (350) the clock 204 with the valid time. The time request message is communicated as a broadcast message, for example, so that each of the other electronic devices 100 receives the time request message simultaneously or almost simultaneously. While broadcast is used throughout the disclosure as a communication mode between the electronic devices 100 in the mesh network 110, other modes of communication can also be utilized by the electronic devices 100, such as unicast (e.g., sent from one node to another node in the mesh network) and groupcast/multicast (sent from one node to a subset, or group, of nodes in the mesh network).

The time range indicating an invalid time range can be the default time (hardcoded into the memory 202 of the electronic device 100) to a first time. In some cases, the first time is December 31^{st} of the year prior to the current year. In a particular embodiment, the first time is Dec. 31, 2022. Thus, a date greater than the time range may indicate the current time.

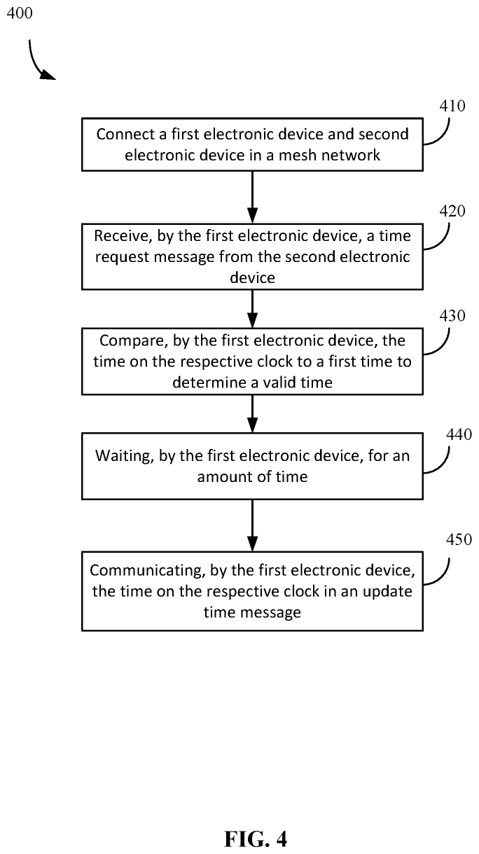

FIG. 4 illustrates a process flow describing a method of creating a virtual cloud network to synchronize a time when a mesh network of electronic devices is offline. Referring to FIG. 4, the method 400 includes connecting (410) a first electronic device and a second electronic device in a mesh network 110 of electronic devices. Each of the first electronic device and the second electronic device includes a respective clock set to a time. The first electronic device and the second electronic device can be part of the mesh network 110 as shown in FIG. 1. The method 400 includes receiving (420), by the first electronic device, a time request message from the second electronic device. The second electronic device is the electronic device 100 in the mesh network 110 that has lost its time as described by method 300. The first electronic device compares (430) the time on its respective clock 204 to a first time to determine that the time on its respective clock 204 is a valid time. A valid time is a time greater than the first time. As discussed previously, in an embodiment, the first time is Dec. 31, 2022. Responsive to the determination that the time indicates a valid time, waiting (440), by the first electronic device, for an amount of time. If the first electronic device does not receive another time sent in an update time message, communicating (450), by the first electronic device, the time on its respective clock to the second electronic device in an update time message. The update time message can be communicated as a broadcast message so that all of the other electronic devices in the mesh network 110 receives the update time message simultaneously, or almost simultaneously.

When the first electronic device determines that its respective clock has the valid time, the first electronic device waits (440) for an amount of time before communicating the time on its respective clock 204 to the second electronic device in the mesh network 110. The first electronic device waits for the amount of time to limit the number of electronic devices 100 in the mesh network 110 responding simultaneously to the time request message and flooding the mesh network 110 with update time messages all having a valid time. In some cases, the amount of time is the last two digits of the electronic device identification number of the corresponding electronic device multiplied by 100 ms. As each electronic device in the mesh network 110 includes a unique electronic identification number, the amount of time that each of the electronic devices waits before sending the update time message will be different. Thus, the flooding of update time messages in the mesh network 110 can be avoided. For example, each electronic device 100 would wait between 4 seconds and 4 minutes depending on its unique electronic identification number.

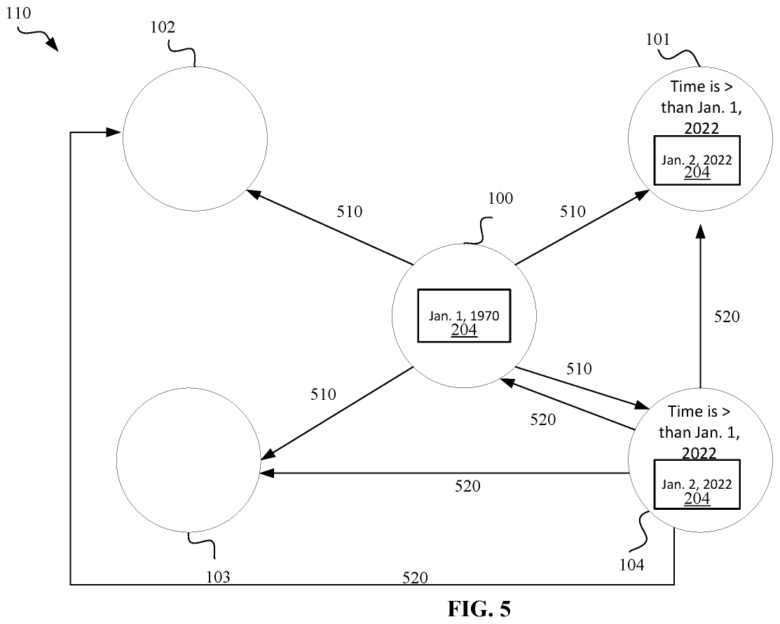

FIG. 5 illustrates an example scenario of time synchronization for offline devices. Referring to FIG. 5, mesh network 110 includes electronic devices, 100, 101, 102, 103, and 104. Electronic devices 100, 101, 102, 103, 104 communicate with each other over the mesh network 110 via broadcast messages. In the example scenario, electronic device 100 has lost its time, either by loss of power or by reset. Once electronic device 100 powers back up, the respective clock 204 on electronic device 100 gets set to the default time that is stored in memory 202. The electronic device 100 checks the time on the respective clock 204, stored in the flash memory. The time on the respective clock 204 is Jan. 1, 1970, which is the default time in the scenario. By comparing the time on the respective clock 204 to a time range, electronic device 100 determines that it has an invalid time. Electronic device 100 then sends out a time request message 510 (indicated by arrows extending away from electronic device 100) via a broadcast message to all the other electronic devices 101, 102, 103, and 104 in mesh network 110.

Each of the other electronic devices 101, 102, 103, 104, upon receiving the time request message 510, checks the time on its respective clock 204. For example, one of the other electronic devices 104, is shown checking the time on its respective clock 204. Electronic device 104 checks its time by comparing the time on its respective clock 204 to a first time to determine if its respective clock 204 has a valid time. The first time, in the illustrated scenario, is Jan. 1, 2022, however, the first time can be any recent time such as the first day of the current year. For example, the first day of the current year is Jan. 1, 2023. As electronic device 104 has a time that is greater than the first time, e.g., Jan. 1, 2022, electronic device 104 marks its time as a valid time. Responsive to having a valid time, electronic device 104 waits an amount of time prior to sending an update time message 520 via a broadcast message to electronic device 100 as well as electronic devices 101, 102, and 103. Since the electronic device 104 does not receive an update time message from other electronic devices 101, 102, 103 in the amount of time, after the amount of time expires, electronic device 104 communicates the time from its respective clock 204 in update time message 420 to each of electronic devices 100, 101, 102, 103.

Electronic device 101 also has checked the time on its respective clock 204 upon receiving time request message 510 from electronic device 100 and has determined that it also has a valid time. When receiving the time request message 510, electronic device 101 also set a timer for an amount of time and is currently waiting for the time to expire. However, during the amount of time, electronic device 101 receives update time message 520 sent from electronic device 104.

Electronic device 101 performs another comparison of the time from its respective clock with the time on the respective clock of electronic device 104 received from the update time message 520. From the comparison, electronic device 101 determines that its time equals the time from the respective clock from the electronic device 104. Electronic device 101 marks its time in memory 202 as valid and does not send an update time message. If, however, electronic device 101 determines that the received time is ahead of (greater than) the time from its respective time, then electronic device 101 will replace its respective time with the received time from electronic device 104. Additionally, if the electronic device 101 determines that its respective time is greater than the received time by an amount of time, such as a minute for example, electronic device can send its respective time, after waiting for a time delay, to the other devices 100, 102, 103, and 104 via a broadcast message.

In operation, when a mesh network of electronic devices is offline such that it has lost connectivity, the mesh network can act as a virtual cloud and synchronize the time between the electronic devices in the mesh network. In some cases, at least one electronic device in the mesh network can include a sensor module having a battery such as a supercapacitor. Thus, in the case where every electronic device in the mesh network loses a common source of power, the electronic device having the sensor module can use its time to synchronize the remaining electronic devices in the mesh network to its time. Then, in the situation that every electronic device loses power, the mesh network only needs one electronic device to have a battery backup in order to synchronize the time within the mesh network, reducing the cost of the mesh network to operate.

Although the subject matter has been described in language specific to structural features and/or acts, it is to be understood that the subject matter defined in the appended claims is not necessarily limited to the specific features or acts described above. Rather, the specific features and acts described above are disclosed as examples of implementing the claims and other equivalent features and acts are intended to be within the scope of the claims.

What is claimed is:

1. A method of time synchronization in an offline environment, the method comprising:
connecting an electronic device in a mesh network of electronic devices so that the mesh network includes the electronic device and other electronic devices, wherein the electronic devices each includes a clock set to a time;
comparing, by the electronic device, the time on the clock to a time range to determine that the time is within the time range indicating an invalid time; and
responsive to the determination that the time is within the time range indicating the invalid time:
communicating, by the electronic device, a time request message to the other electronic devices in the mesh network;
receiving, by the electronic device, a valid time from one of the other electronic devices in the mesh network; and
synchronizing, by the electronic device, the clock with the valid time.

2. The method according to claim 1, wherein the method is performed upon a power-up sequence on the electronic device.

3. The method according to claim 1, wherein the method is performed periodically at a specific time interval.

4. The method according to claim 1,
wherein communication between the electronic devices of the mesh network, including between the electronic device and the other electronic devices, is broadcast.

5. The method according to claim 1, wherein the mesh network is a Bluetooth® low energy network.

6. The method according to claim 1, wherein the time range is a default time to a first time.

7. The method according to claim 6, wherein the default time is Jan. 1, 1970.

8. The method according to claim 6, wherein the first time is Dec. 31, 2022.

9. A method of creating a virtual cloud network to synchronize a time when a mesh network of electronic devices is offline, the method comprising:
connecting a first electronic device and a second electronic device in a mesh network wherein each of the first electronic device and the second electronic device includes a clock set to a time;
receiving, by the first electronic device in the mesh network, a time request message from the second electronic device in the mesh network that has determined the time on the respective clock of the second electronic device is set to an invalid time;
comparing, by the first electronic device, the time on the respective clock of the first electronic device to a first time to determine a valid time; and
responsive to determining the time on the respective clock of the first electronic device indicates the valid time:
waiting, by the first electronic device, an amount of time based on an electronic device identification number of the first electronic device; and
when a first update time message is not received by the first electronic device during the amount of time, communicating, by the first electronic device, the time on the respective clock of the first electronic device in a second update time message to the second electronic device.

10. The method according to claim 9, wherein communication between electronic devices in the mesh network, including between the first electronic device and the second electronic device, is broadcast.

11. The method according to claim 9, wherein the valid time is greater than the first time.

12. The method according to claim 11, wherein the first time is Dec. 31, 2022.

13. The method according to claim 9, further comprising marking the time on the respective clock of the first electronic device as valid in memory when the time is the valid time.

14. The method according to claim 9, wherein the amount of time is a last two digits of an electronic device identification number multiplied by 100 ms.

15. The method according to claim 9, wherein one electronic device of the electronic devices in the mesh network further comprises a sensor module including a supercapacitor.

16. The method according to claim 15, wherein the sensor module is a plug and play module so that the sensor module is movable between electronic devices in the mesh network.

17. The method according to claim 11, further comprising connecting a third electronic device in the mesh network, wherein the third electronic device includes a clock set to a time.

18. The method according to claim 17, further comprising receiving, by the third electronic device, the second update time message comprising the time on the respective clock of the first electronic device, and comparing, by the third electronic device, the time on the respective clock of the third electronic device to the received time on the respective clock on the first electronic device to determine the valid time or an invalid time,
wherein the invalid time is less than or equal to the first time.

19. The method according to claim 18, further comprising responsive to the determination that the time on the respective clock of the third electronic device is the invalid time, setting the time on the respective clock on the third electronic device to the received time on the respective clock on the first electronic device.

20. The method according to claim 18, further comprising responsive to the determination that the time of the respective clock of the third electronic device is the valid time:
comparing, by the third electronic device, the time of the respective clock of the third electronic device to the received time on the respective clock of the first electronic device to determine that the received time on the respective clock is greater than the time of the respective clock of the third electronic device; and
responsive to the received time on the respective clock of the first electronic device being greater than the time of the respective clock of the third electronic device,
setting, by the third electronic device, the time on the respective clock of the third electronic device to the received time on the respective clock of the first electronic device.
